(19) United States
(12) Patent Application Publication
(10) Pub. No.: US 2013/0141382 A1
(43) Pub. Date: Jun. 6, 2013

(54) Touch Sensor With Force Sensing

(71) Applicants: Martin John Simmons, Southampton (GB); Darren Golbourn, Southampton (GB); Andrew Hersee, Southampton (GB)

(72) Inventors: Martin John Simmons, Southampton (GB); Darren Golbourn, Southampton (GB); Andrew Hersee, Southampton (GB)

(21) Appl. No.: 13/309,103

(22) Filed: Dec. 1, 2011

(51) Int. Cl. G06F 3/044

(52) U.S. Cl. 345/174; 178/18.06

(57) ABSTRACT

In one embodiment, a touch sensor includes a panel, a plurality of sense electrodes underlying the panel, a plane of known potential underlying the plurality of sense electrodes, and a controller communicatively coupled to the plurality of sense electrodes. The controller is configured to determine whether an object has pressed the panel by: measuring capacitances at each of a plurality of sense electrodes across the panel, the capacitances associated with a distance between the plurality of sense electrodes and the plane of known potential, comparing the measured capacitances across the panel with one or more criteria associated with a deformation of the panel, and determining, based on the comparison, whether an object has pressed the panel.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid, for example, on a display screen. In a touch-sensitive-display application, the touch sensor may enable a user to interact directly with what is displayed on the screen, rather than indirectly with a mouse or touchpad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are different types of touch sensors, such as (for example) resistive touch screens, surface acoustic wave touch screens, capacitive touch screens, infrared touch screens, and optical touch screens. Herein, reference to a touch sensor may encompass a touch screen, and vice versa, where appropriate. A capacitive touch screen may include an insulator coated with a substantially transparent conductor in a particular pattern. When an object touches or comes within proximity of the surface of the capacitive touch screen, a change in capacitance may occur within the touch screen at the location of the touch or proximity. A controller may process the change in capacitance to determine the touch position(s) on the touch screen.

### BRIEF DESCRIPTION OF THE DRAWINGS

FIG. 1 illustrates an example device with a touch-sensitive area, according to certain embodiments;

FIG. 2 illustrates an example embodiment of the touch sensor of FIG. 1, according to certain embodiments;

FIG. 3 illustrates a side view of one embodiment of the touch sensor of FIG. 2 in which touch objects lightly touch or are in close enough proximity to the touch sensor to cause a detectable change in capacitance, according to certain embodiments;

FIG. 4 illustrates an example embodiment of the touch sensor of FIG. 3, according to certain embodiments;

FIG. 5 illustrates a side view of one embodiment of the touch sensor of FIG. 2 in which touch objects intentionally press the touch sensor and cause the touch sensor to deform, according to certain embodiments;

FIG. 6 illustrates an example embodiment of the touch sensor of FIG. 5, according to certain embodiments;

FIG. 7 illustrates an example method that may be used in certain embodiments to determine whether an object has pressed a touch sensor, according to certain embodiments; and

FIGS. 8-9 are example capacitance charts that illustrate capacitance magnitudes obtained from an experiment conducted using a sample embodiment of the disclosure.

### DESCRIPTION OF EXAMPLE EMBODIMENTS

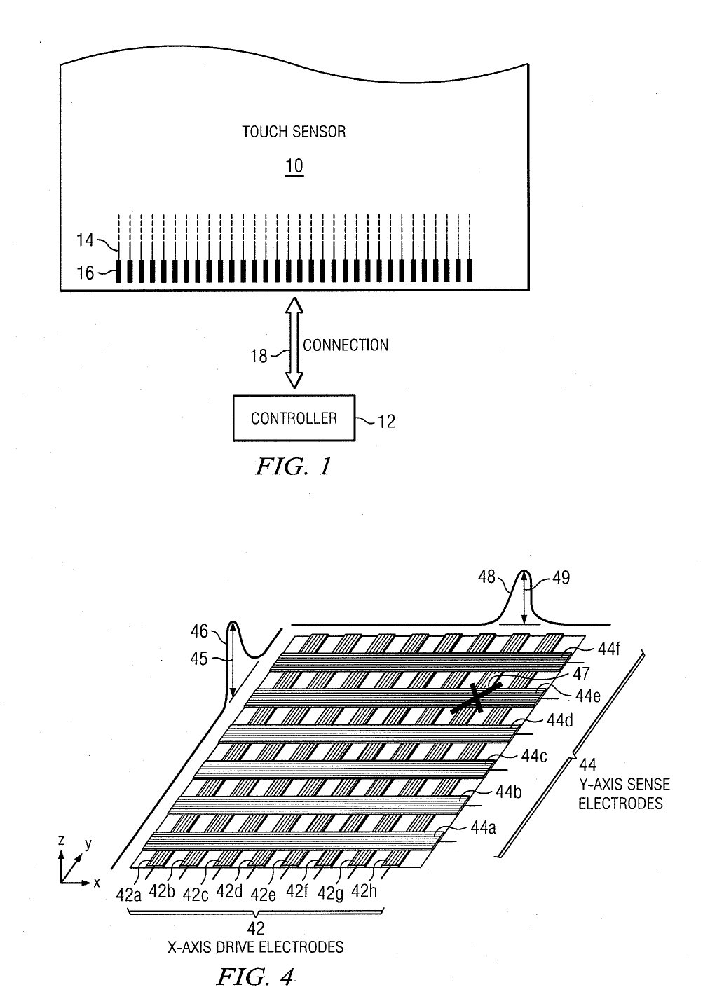

FIG. 1 illustrates an example touch sensor 10 with an example controller 12. Herein, reference to a touch sensor may encompass a touch screen, and vice versa, where appropriate. Touch sensor 10 and controller 12 may detect the presence and location of a touch or the proximity of an object within a touch-sensitive area of touch sensor 10. Herein, reference to a touch sensor may encompass both the touch sensor and its controller, where appropriate. Similarly, reference to a controller may encompass both the controller and its touch sensor, where appropriate. Touch sensor 10 may include one or more touch-sensitive areas, where appropriate. Touch sensor 10 may include an array of drive and sense electrodes disposed on a substrate, which may be a dielectric material.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of indium tin oxide (ITO) in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a gap between them. A pulsed or alternating voltage applied to the drive electrode (i.e., by controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and controller 12 may measure the change in capacitance. By measuring changes in capacitance throughout the array, controller 12 may determine the position of the touch or proximity within the touch-sensitive area(s) of touch sensor 10.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have a single-layer configuration, with drive and sense electrodes disposed in a pattern on one side of a substrate. In such a configuration, a pair of drive and sense electrodes capacitively coupled to each other across a space between them may form a capacitive node. In a single-layer configuration for a self-capacitance implementation, electrodes of only a single type (e.g. drive) may be disposed in a pattern on one side of the substrate. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Controller 12 may detect and process the change in capacitance to determine the presence and location of the touch or proximity input. Controller 12 may then communicate information about the touch or proximity input to one or more other components (such one or more central processing units (CPUs) or digital signal processors (DSPs)) of a device that includes touch sensor 10 and controller 12, which may respond to the touch or proximity input by initiating a function of the device (or an application running on the device) associated with it. Although this disclosure describes a particular controller having particular functionality with respect to a particular device and a particular touch sensor, this disclosure contemplates any suitable controller having any suitable functionality with respect to any suitable device and any suitable touch sensor.

Controller 12 may be one or more integrated circuits (ICs)—such as for example general-purpose microprocessors, microcontrollers, programmable logic devices or arrays, application-specific ICs (ASICs) and may be on a flexible printed circuit (FPC) bonded to the substrate of touch sensor 10, as described below. Controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular controller having a particular implementation with particular components, this disclosure contemplates any suitable controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to controller 12. Tracks 14 may extend into or around (e.g. at the edges of) the touch-sensitive area(s) of touch sensor 10. Particular tracks 14 may provide drive connections for coupling controller 12 to drive electrodes of touch sensor 10, through which the drive unit of controller 12 may supply drive signals to the drive electrodes. Other tracks 14 may provide sense connections for coupling controller 12 to sense electrodes of touch sensor 10, through which the sense unit of controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (similar to a connection pad 16) at an edge of the substrate of touch sensor 10 (similar to tracks 14).

Connection pads 16 may be located along one or more edges of the substrate, outside the touch-sensitive area(s) of touch sensor 10. As described above, controller 12 may be on an FPC. Connection pads 16 may be made of the same material as tracks 14 and may be bonded to the FPC using an anisotropic conductive film (ACF). Connection 18 may include conductive lines on the FPC coupling controller 12 to connection pads 16, in turn coupling controller 12 to tracks 14 and to the drive or sense electrodes of touch sensor 10. In another embodiment, connection pads 160 may be inserted into an electro-mechanical connector (such as a zero insertion force wire-to-board connector); in this embodiment, connection 180 may not need to include an FPC. This disclosure contemplates any suitable connection 18 between controller 12 and touch sensor 10.

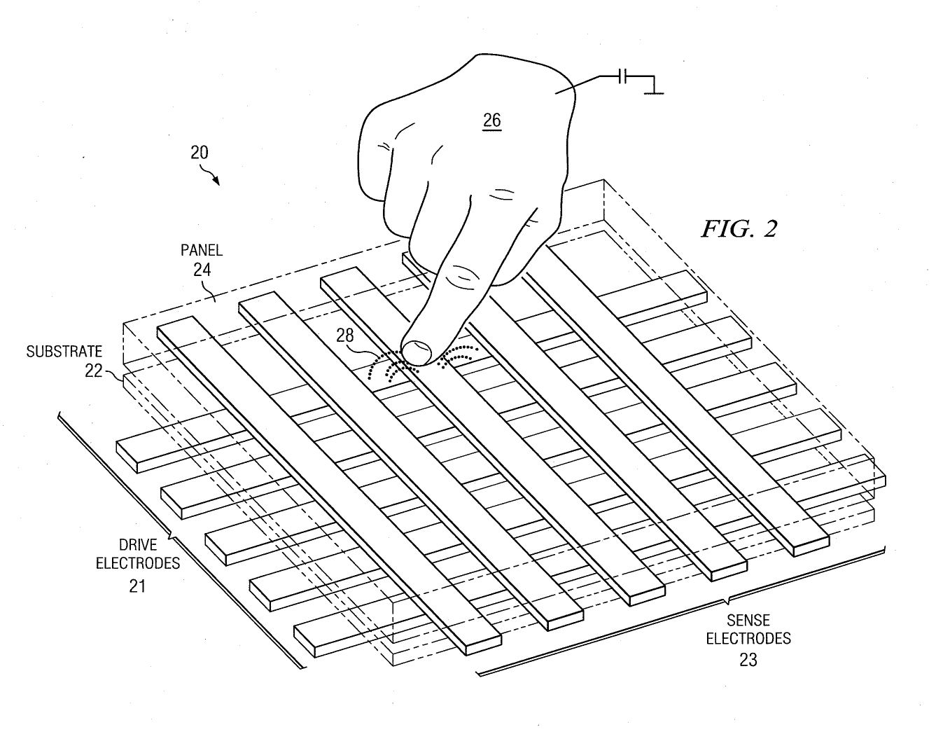

FIG. 2 illustrates a touch sensor 20 that may be utilized as touch sensor 10 of FIG. 1. Touch sensor 20 includes drive electrodes 21, a substrate 22, sense electrodes 23, and a panel 24. In some embodiments, panel 24 is a transparent panel. In some embodiments, substrate 22 is sandwiched between drive electrodes 21 and sense electrodes 23, and sense electrodes 23 are coupled to an underside of panel 24 with, for example, an adhesive. In other embodiments, touch sensor 20 may include any appropriate configuration and number of layers of electrodes and substrates. For example, some embodiments of touch sensor 20 may include additional layers of sense electrodes 23 that may run perpendicular (or any other appropriate angle) to the sense electrodes 23 illustrated in FIG. 2.

In general, touch sensor 20 may be configured to determine whether a touch object 26 (e.g., a portion of a human hand, a stylus, etc.) has intentionally pressed panel 24. As used herein, “press” or “pressed” generally refers to touch object 26 touching panel 24 intentionally in order to interact with a touch-sensitive application displayed on a display screen positioned under touch sensor 20. Generally, an intentional press by touch object 26 results in a deformation of panel 24. Embodiments of the disclosure distinguish between intentional presses of panel 24 and other “unintentional” detections of touch object 26 by touch sensor 20. Other “unintentional” detections of touch object 26 by touch sensor 26 may include situations such as touch object 26 merely lightly touching (i.e., scraping or grazing) panel 24 (i.e., by an ear or coin) or touch object 26 merely coming within close proximity to panel 24 but not actually physically touching panel 24 (i.e., a stylus hovering close to the surface of panel 24). As discussed in more detail below, embodiments of the disclosure determine whether touch object 26 has pressed panel 24 by analyzing measured capacitances of sense electrodes 23 across an active touch area (i.e., panel 24) and then determining, based on the analysis of the capacitances of the sense electrodes across the active touch area, whether the active touch area has been deformed.

In certain embodiments, electrodes 21 and 23 may be configured in a manner substantially similar to the drive and sense electrodes, respectively, described above with reference to FIG. 1, and touch object 26 may be capacitively coupled to ground. In certain embodiments, touch sensor 20 may determine the location of touch object 26 at least in part by using controller 12 to apply a pulsed or alternating voltage to drive electrodes 21, which may induce a charge on sense electrodes 23. When touch object 26 touches or comes within proximity of an active area of touch sensor 20, a change in capacitance may occur, as depicted by electric field lines 28 in FIG. 2. The change in capacitance may be sensed by sense electrodes 23 and measured by controller 12. By measuring changes in capacitance throughout an array of sense electrodes 23, controller 12 may determine the position of the touch or proximity within the touch-sensitive area(s) of touch sensor 20. In addition, as described further below, controller 12 may determine whether touch object 26 has intentionally pressed the active touch area (i.e., panel 24) by analyzing the measured changes in capacitances of sense electrodes 23 across the active touch area of touch sensor 20 and determining, based on the analysis of the capacitances across the active touch area, whether the active touch area has been deformed.

As described above, touch sensor 20 is operable to detect when touch object 26 touches an active area of touch sensor 20, or when touch object 26 comes within proximity to an active area of touch sensor 20 (e.g., touch object 26 is close enough to touch sensor 20 to cause a detectable change in capacitance across sense electrodes 23 but does not physically contact touch sensor 20.) In some situations, however, it may be desirable to determine whether touch object 26 has intentionally pressed touch sensor 20. For example, in situations where touch object 26 is a stylus or a person's finger that is being utilized to write on an active area of touch sensor 20, touch object 26 may only be raised off of touch sensor 20 by a small amount (i.e., between the end of writing one letter and the beginning of writing a new letter). As another example, touch object 26 may be a person's ear or a coin in a pocket that is in close proximity to touch sensor 20 or lightly touches/grazes touch sensor 20. In these situations, touch object 26 does not intentionally press touch sensor 20, but instead merely grazes touch sensor 20 or is in close enough proximity to touch sensor 20 to cause a change in capacitance and thus be registered as an intentional press. Embodiments of the disclosure determine whether touch object 26 has intentionally pressed touch sensor 20 by determining whether panel 24 has been contacted by touch object 26 with enough force to deform panel 24. However, unlike other touch sensors that may utilize a dedicated force sensor to determine forces in which objects contact panel 24, embodiments of the disclosure determine whether panel 24 has been deformed using electrodes 42 and 44 as described further below.

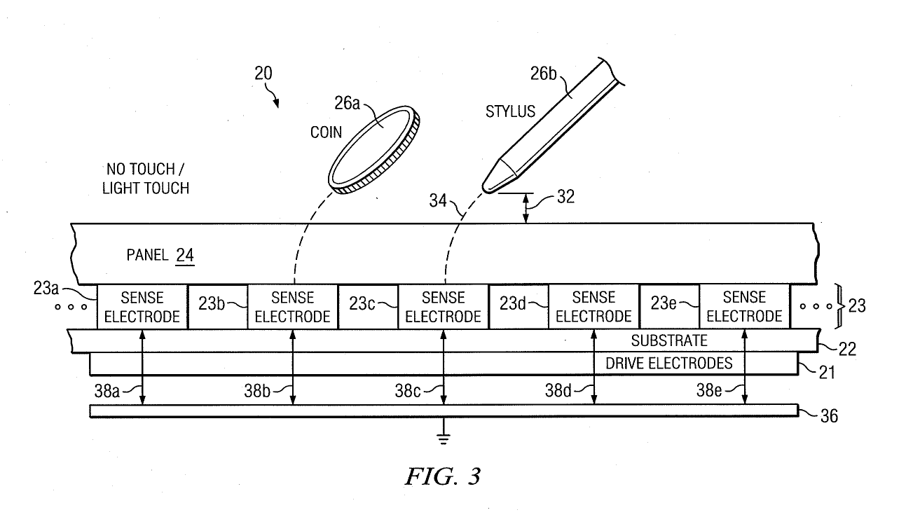

FIG. 3 illustrates a side view of one embodiment of touch sensor 20 in which touch objects 26 (i.e., a coin 26a or a stylus 26b) lightly touch or are in close enough proximity to touch sensor 20 to cause a detectable change in capacitance across sense electrodes 23, but do not intentionally press touch sensor 20 (i.e., do not intentionally press panel 24). For example, stylus 26b, which may be used by a user to write on panel 24, may be lifted off of panel 24 by a distance 32 after the completion of a letter or a word. As another example, coin 26a may be within distance 32 of panel 24 or may lightly graze or touch panel 24. However, due to the sensitivity of sense electrodes 23, a change in capacitance may still be detected by one or more sense electrodes 23 (i.e., sense electrode 23c) as depicted by electric field line 34. In certain embodiments, the capacitance changes may be associated with a distance 38 (e.g., distances 38a-38e) between sense electrodes 23 and a ground plane 36 of device 20 (i.e., capacitance changes detected by sense electrodes 23 may increase as distances 38 between sense electrodes 23 and ground plane 36 decrease, and vice versa). In certain embodiments, ground plane 36 may alternatively be any plane having a known potential. After detecting the change in capacitance, sense electrode 23c may communicate the change in capacitance to controller 12 via connection 18. A detection of a change in capacitance due to a touch object 26 coming in proximity to touch sensor 20 is further illustrated in reference to FIG. 4 below.

FIG. 4 illustrates an example embodiment of touch sensor 20 having a grid of x-axis drive electrodes 42 and y-axis sense electrodes 44 and illustrates a detection of a change in capacitance due to a touch object 26 coming in proximity to or lightly touching panel 24. As illustrated in FIG. 4, touch sensor 20 may include multiple electrodes 42/44 arranged substantially parallel to either the x-axis or y-axis. In certain embodiments, the x-axis may be not be parallel to the y-axis (e.g. the x-axis may be rotated with respect to the y-axis about an angle of approximately 90 degrees, 120 degrees, 130 degrees, or any other suitable angle). Electrodes 42 and 44 may be substantially similar to drive electrodes 21 and sense electrodes 23, respectively, and may collectively form a substantially two-dimensional grid configuration. The z-axis in FIG. 4 illustrates a representation of capacitances caused by a touch object 26 as detected by one or more electrodes 42/44. Typically, mutual-capacitance devices such as touch sensor 20 produce capacitance data as a matrix of two-dimensional numbers. Lines 46 and 48 are projections of the two-dimensional capacitance numbers that may be produced by touch sensor 20.

Although the example touch sensor 20 of FIG. 4 is configured as a rectangular grid, other configurations are within the scope of the invention, such as a touchwheel, a linear slider, buttons with reconfigurable displays, and other like configurations. In certain embodiments, redundant fine line metal electrodes to provide open fault resiliency may be applied to any such configuration, and the disclosure is not limited to the example configurations presented here.

In operation of example embodiments of FIGS. 3-4, a touch object 26 comes in close proximity to or lightly touches panel 24 at location 47 (e.g., does not intentionally press panel 24). For example, stylus 26b comes within close enough proximity to panel 24 to cause a detectable change in capacitance across electrodes 42/44, but does not physically contact panel 24. As another example, coin 26a lightly grazes or touches panel 24 and thus causes a detectable change in capacitance across electrodes 42/44. Electrodes 42/44 detect the change in capacitance due to touch object 26 and communicate the change in capacitance to controller 12. For example, as depicted in line 46, y-axis sense electrode 44e senses a change in capacitance of magnitude 45 while the remaining y-axis sense electrodes 44 sense little or no change in capacitance. Similarly, line 48 depicts a change in capacitance of magnitude 49 at electrode 42g, while little or no change in capacitance is sensed anywhere else along the x-axis. Once controller 12 receives change in capacitance measurements from electrodes 42/44, controller 12 determines whether touch object 26 has intentionally pressed panel 24, as described further below.

In general, a touch object 26 coming within close proximity to or lightly touching panel 24, as illustrated in FIGS. 3-4, results in localized changes in capacitance across electrodes 42/44 and do not cause changes in capacitance across the entire panel 24. For example, as illustrated in FIG. 4, only one electrode 42/44 on each axis senses a change in capacitance caused by touch object 26. As another example, only a limited number of electrodes surrounding location 47 may sense a change in capacitance caused by touch object 26 while the majority of electrodes 42/44 detect little or no changes in capacitance (i.e., changes in capacitance less than a predetermined threshold). In general, an unintentional touch of panel 24 (i.e., a touch object 26 coming in close proximity to or lightly touching panel 24) does not result in a deformation of panel 24 and does not cause significant changes in capacitance across the entire panel 24. Embodiments of the disclosure utilize capacitance measurements across panel 24 to determine whether touch object 26 has intentionally pressed panel 24.

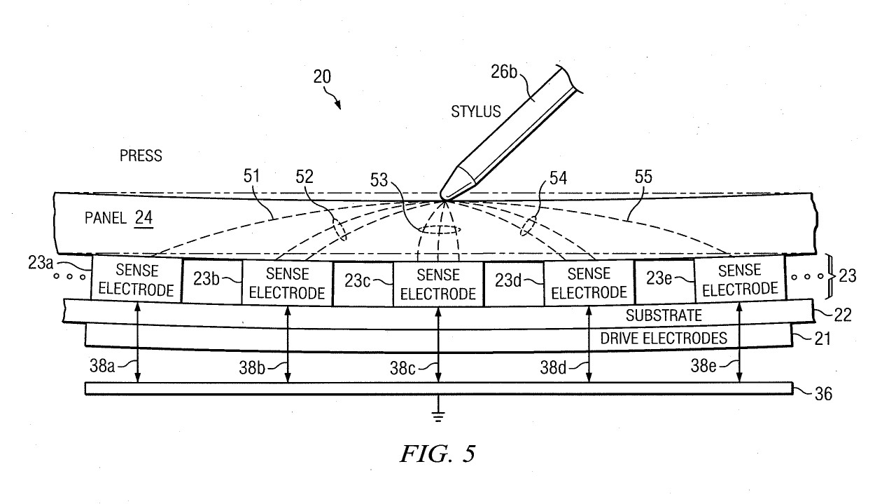

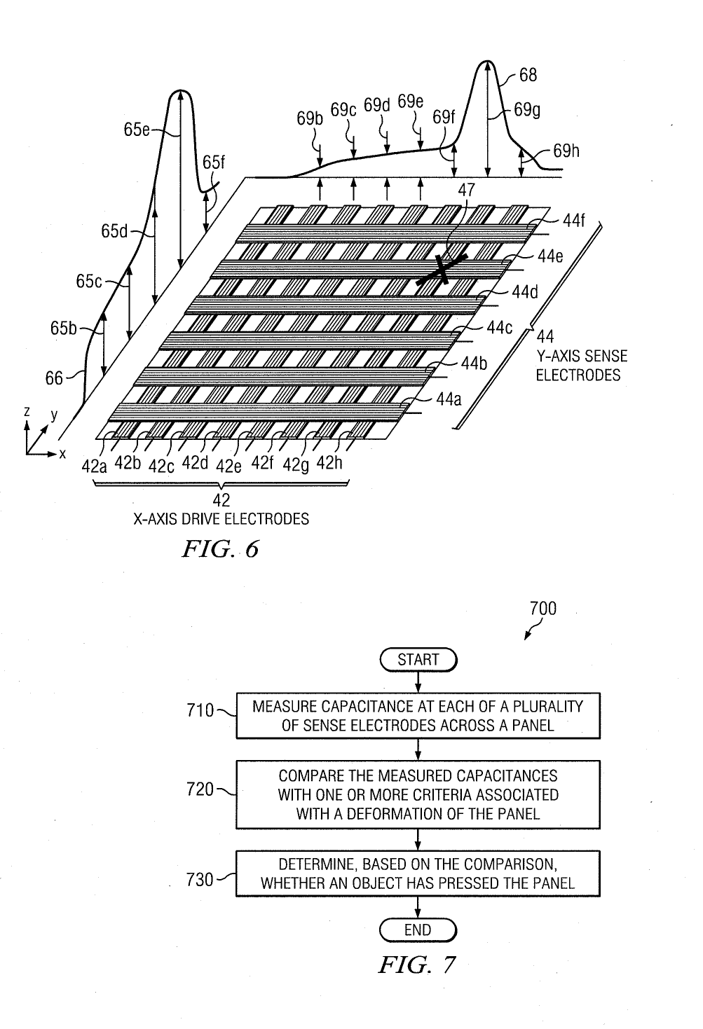

FIG. 5 illustrates a side view of one embodiment of touch sensor 20 in which touch objects 26 (i.e., stylus 26b) intentionally press panel 24 and thus cause panel 24 to deform. Similar to FIGS. 3-4 described above, an intentional press of panel 24 by touch object 26 causes a detectable change in capacitance across sense electrodes 23. However, unlike the embodiments of FIGS. 3-4 in which touch objects do not physically touch or only lightly touch panel 24, an intentional press of panel 24 by touch object 26 may deform panel 24 as illustrated in FIG. 5 and may be detected by multiple sense electrodes 23. For example, a press of panel 24 by touch object 26 may result in changes in capacitance across multiple sense electrodes 23 (i.e., sense electrode 23a-23e) as depicted by electric field lines 51-55. Because sense electrode 23c is directly under the location in which touch object 26 pressed on panel 24, the distance 38c between it and ground plane 36 decreased the greatest amount (e.g., distance 38c is less than distances 38a-38b and 38d-38d). But because panel 24 deformed due to touch object 26 pressing on it, the remaining sense electrodes 23 also moved closer to ground plane 36. As a result, sense electrode 23c may report a large change in capacitance and the remaining sense electrodes 23 may report a change in capacitance smaller than that of sense electrode 23c. After detecting the changes in capacitance, sense electrodes 23a-23e may communicate the changes in capacitance to controller 12 via connection 18. A detection of changes in capacitance across panel 24 due to a touch object 26 pressing panel 24 is further illustrated in reference to FIG. 6 below.

FIG. 6 illustrates an example embodiment of touch sensor 20 that illustrates a detection of a change in capacitances due to a touch object 26 intentionally pressing panel 24 at location 47. Similar to FIG. 4 discussed above, lines 66 and 68 represent a magnitude of change in capacitance caused by a touch object 26 pressing panel 24 as detected by one or more electrodes 42/44. In this embodiment, however, touch object 26 presses on and physically deforms panel 24 at location 47 instead of merely coming in proximity to or lightly touching panel 24. Electrodes 42/44 detect the change in capacitance due to touch object 26 pressing panel 24 and communicate the change in capacitance to controller 12. For example, line 66 represents changes in capacitance along the y-axis of magnitudes 65b-65f, respectively. Similarly, line 68 represents changes in capacitance of magnitudes 69b-69h, respectively, along the x-axis. Once controller 12 receives change in capacitance measurements from electrodes 42/44, controller 12 analyzes the measurements and determines whether touch object 26 has intentionally pressed panel 24, as described further below.

In general, a touch object 26 intentionally pressing panel 24, as illustrated in FIGS. 5-6, results in a deformation (i.e., a bend or a curvature) of panel 24. In addition, a touch object 26 intentionally pressing panel 24 results in changes in capacitance that may be detected across a majority of or the entire panel 24. For example, as illustrated in FIG. 6, changes in capacitance of magnitudes 65b-65f along the y-axis and changes in capacitance of magnitudes 69b-69h along the x-axis are sensed when touch object 26 presses panel 24 at location 47. In contrast to an unintentional touch as described above that results in only localized changes in capacitance, an intentional press of panel 24 by touch object 26 results in a deformation of panel 24 and causes significant changes in capacitance across the entire panel 24 or a substantial portion of panel 24.

In reference to FIGS. 3-6, controller 12 determines whether touch object 26 has intentionally pressed panel 24 by analyzing change in capacitance measurements from electrodes 42/44. In certain embodiments, controller 12 may determine whether touch object 26 has intentionally pressed panel 24 by analyzing the change in capacitance measurements from electrodes 42/44 across an active touch area of touch sensor 20 (i.e., panel 24) to determine whether the active touch area has been deformed. For example, controller 12 may compare the change in capacitance measurements from electrodes 42/44 with one or more criteria associated with a deformation of the panel. While any appropriate method of analyzing capacitance measurements from electrodes 42/44 may be utilized by controller 12 to determine whether panel 24 has been deformed, certain example methods are discussed below for illustration purposes only.

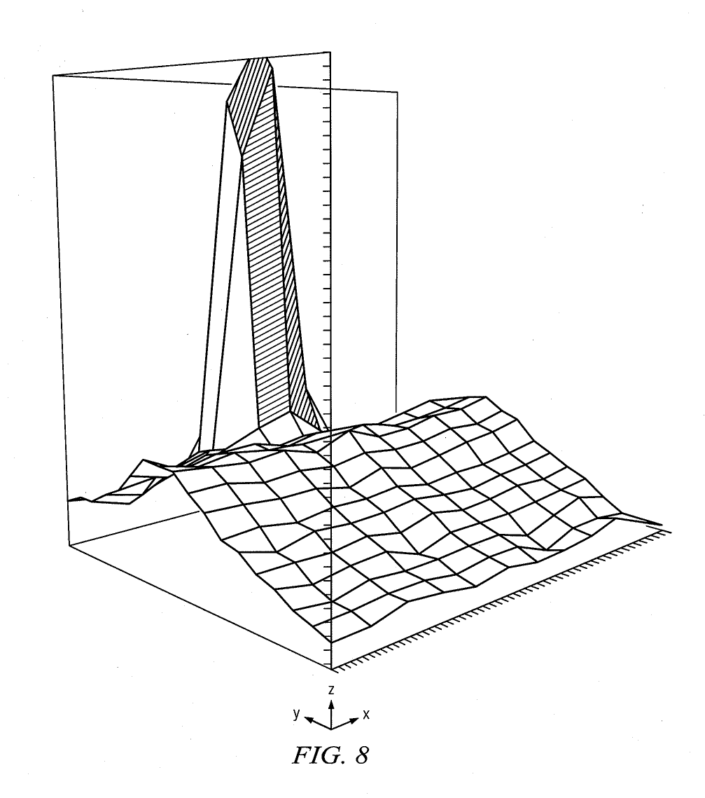

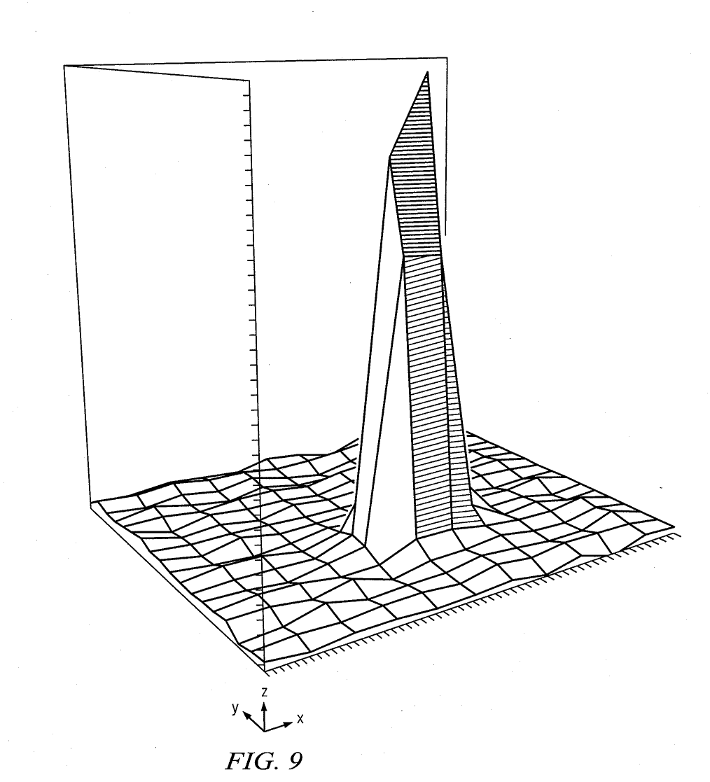

In certain embodiments, controller 12 may determine whether panel 24 has been deformed (and therefore that touch object 26 has intentionally pressed panel 24) by measuring capacitances at electrodes 42/44 across panel 24, determining a graph of the measured capacitances, and then determining whether touch object 26 intentionally pressed panel 24 based on the determined graph of the measured capacitances. For example, FIGS. 8-9 below illustrated example capacitance graphs that may be similar to the graph of the measured capacitances determined by controller 12. In certain embodiments, controller 12 may compare the shape of the determined graph of the measured capacitances with a stored graph of a known press (i.e., a graph of a known press that is stored in a deformation profile as described below) in order to determine whether touch object 26 intentionally pressed panel 24. In certain embodiments, controller 12 may determine a maximum magnitude of the determined graph of the measured capacitances and then compare the maximum magnitude with a predetermined threshold. For example, controller 12 may determine that touch object 26 intentionally pressed panel 24 when the determined maximum magnitude of the determined graph is greater than or equal to a predetermined threshold. Conversely, controller 12 may determine that touch object 26 did not intentionally press panel 24 when the determined maximum magnitude of the determined graph is less than the predetermined threshold. In certain embodiments, controller 12 may calculate an area of the determined graph in which one or more of sense electrodes 23 have sensed a change in capacitance and then compare the calculated area with a predetermined area. Controller 12 may determine that touch object 26 intentionally pressed panel 24 when the calculated area is greater than or equal to the predetermined area, and that touch object 26 did not intentionally press panel 24 when the calculated area is less than the predetermined area.

In certain embodiments, controller 12 may determine whether panel 24 has been deformed by determining the number of electrodes 42/44 that have sensed a change in capacitance and then comparing the number with one or more criteria associated with a deformation of the panel. For example, controller 12 may determine whether panel 24 has been deformed by determining the total number of sense electrodes 44 that have sensed a change in capacitance and then comparing the number with a predetermined limit. As an example for illustration purposes only, a predetermined limit of four sense electrodes may be programmed into controller 12. Controller 12 may then determine the total number of sense electrodes 44 that have sensed a change in capacitance due to touch object 26 and then determine whether the number is less than or greater than four. If the total number of sense electrodes 44 that have sensed a change in capacitance due to touch object 26 is less than four, controller 12 may determine that panel 24 has not been deformed and consequently that touch object 26 has not intentionally pressed panel 24. Conversely, if the total number of sense electrodes 44 that have sensed a change in capacitance is equal to or greater than four, controller 12 may determine that panel 24 has been deformed and consequently that touch object 26 has intentionally pressed panel 24. In the illustrated embodiment of FIG. 4, for example, controller 12 may determine that only one sense electrode 44 (e.g, y-axis sense electrode 44e) sensed a change in capacitance due to touch object 26. Controller 12 then determines that one is less than the predetermined limit of four and therefore determines that panel 24 has not been deformed. In the illustrated embodiment of FIG. 6, however, controller 12 determines that five sense electrodes 44 (e.g, y-axis sense electrodes 44b-44f) sensed a change in capacitance due to touch object 26 (e.g., magnitudes 65b-65f). Thus, controller 12 in the illustrated embodiment of FIG. 6 determines that five is greater than the predetermined limit of four and therefore determines that panel 24 has been deformed. While a predetermined limit of four sense electrodes has been discussed in these examples, any appropriate limit of sense electrodes may be utilized to determine whether panel 24 has been deformed.

In certain embodiments, controller 12 may determine whether panel 24 has been deformed by calculating an area of panel 24 in which one or more electrodes 42/44 have sensed a change in capacitance and then comparing the calculated area with a predetermined area. In certain embodiments, controller 12 may calculate an area of panel 24 by multiplying the number of x-axis drive electrodes 42 with the number of y-axis sense electrodes 44 that have sensed a change in capacitance. In other embodiments, controller 12 may access data indicating dimensions of panel 24 and may utilize the dimensions and the electrodes 42/44 that have sensed a change in capacitance to calculate the area. After calculating the area of panel 24 in which one or more electrodes 42/44 have sensed a change in capacitance, controller 12 may compare the calculated area to a predetermined area. If the calculated area is less than the predetermined area, controller 12 may determine that panel 24 has not been deformed and thus that panel 24 was not intentionally pressed. Conversely, if the calculated area is greater than or equal to the predetermined area, controller 12 may determine that panel 24 has been deformed and thus that panel 24 was intentionally pressed. While certain examples of calculating an area of panel 24 in which electrodes 42/44 have sensed a change in capacitance, any appropriate method of calculating the area may be utilized by controller 12.

In certain embodiments, controller 12 may compare the capacitance measurements reported by each sense electrode 44 to a predetermined magnitude in determining whether the active touch area has been deformed. For example, a predetermined magnitude may be programmed into controller 12, and controller 12 may compare the change in capacitance measurement reported by each sense electrode 44 to the predetermined magnitude in order to determine whether the particular sense electrode 44 has sensed a change in capacitance large enough to be considered as a detection. As an illustration, consider TABLE 1 below that lists example changes in capacitance magnitudes 65 that may be reported to controller 12:

TABLE 1
Change in Capacitance Measurements

| MAGNITUDE | VALUE |
|---|---|
| 65b | 850 |
| 65c | 900 |
| 65d | 1500 |
| 65e | 2300 |
| 65f | 600 |

In this example, also consider that a predetermined magnitude of 650 is programmed into controller 12. Here, controller 12 compares the change in capacitance magnitudes 65b-65f in TABLE 1 to the predetermined magnitude of 650 and determines that change in capacitance magnitudes 65b-65e are larger than the predetermined magnitude of 650, and change in capacitance magnitude 65f less than the predetermined magnitude of 650. Thus, controller 12 determines that the total number of electrodes that have sensed enough of a change in capacitance to be considered as a detection is four. As described above, controller 12 may then compare this number (e.g., four) to a predetermined limit to determine whether panel 24 has been deformed. While a predetermined magnitude of 650 has been discussed in these examples, any appropriate magnitude may be utilized to determine whether a particular electrode 44 has sensed a change in capacitance large enough to be considered as a detection.

In certain embodiments, deformation profiles may be utilized to determine whether panel 24 has been intentionally pressed. In certain embodiments, deformation profiles may be stored in the storage unit of controller 12 described above. In other embodiments, deformation profiles may be stored in any appropriate storage device assessable to controller 12. In general, a deformation profile may indicate a particular pattern of electrodes 42/44 associated with a deformation of and/or an intentional press of panel 24. For example, a deformation profile may indicate a minimum number of electrodes 42/44 reporting a change in capacitance greater a predetermined threshold that is associated with a deformation of and/or an intentional press of panel 24. As another example, a deformation profile may indicate a specific shape of a graph of capacitances that is associated with a deformation of and/or an intentional press of panel 24. Particular examples of capacitance graphs are illustrated below in reference to FIGS. 8-9.

In certain embodiments, each user of a device utilizing touch sensor 20 may have an associated deformation profile stored in controller 12 (or any other suitable storage device accessible to controller 12) that indicates an intentional press of panel 24 by the user. In other embodiments, a generic deformation profile may be stored in controller 12 that indicates an intentional press of panel 24 by any user. In embodiments where each particular user has an associated deformation profile, controller 12 may first determine an identification of the particular user who is currently interacting with touch sensor 20 and then utilize the identification to access the user's associated deformation profile. In embodiments where a generic deformation profile is used, controller 12 may utilize the generic deformation profile for each user interacting with touch sensor 20.

Controller 12 may access stored deformation profiles after a detection of a change in capacitance by one or more electrodes 42/44 and determine, based on the accessed deformation profile, whether an object has pressed an active touch area (i.e., panel 24). In certain embodiments, for example, controller 12 may compare the total number of electrodes 42/44 reporting a change in capacitance with a number in the accessed deformation profile. In certain embodiments, controller 12 may compare a pattern of electrodes 42/44 reporting a change in capacitance with a pattern of electrodes 42/44 in the deformation profile. In certain embodiments, controller 12 may generate a graph of capacitances reported by electrodes 42/44 and utilize any appropriate graphical comparison technique to compare it with a capacitance graph in the deformation profile.

In certain embodiments, controller 12 may update the stored deformation profiles in order to more accurately determine whether a touch object 26 has intentionally pressed panel 24. In certain embodiments, controller 12 may automatically update deformation profiles after each user interaction with touch sensor 12. In other embodiments, controller 12 may update deformation profiles after a set number of interactions with touch sensor 12 by a user and/or after a certain period of time. In certain embodiments, controller 12 may receive feedback from a touch-sensitive-display application regarding the user's interaction and use the feedback to update the stored deformation profiles. For example, the touch-sensitive-display application may indicate to controller 12 whether a particular user interaction was an intentional press or not of panel 24. Controller 12 may then update a particular deformation profile according to the feedback so that future interactions by the user will result in more accurate detections of intentionally presses of panel 24.

In some embodiments, controller 12 may generate a deformation profile after a touch object 26 is first detected by electrodes 42/44 and store the generated deformation profile to use to analyze subsequent interactions by touch objects 26. As an example for illustrative purposes only, consider the data from TABLE 1 above that lists example changes in capacitance magnitudes 65 that may be reported to controller 12 by sense electrodes 44. Controller 12 may store this data in a deformation profile and use the deformation profile to determine whether subsequent touch objects 26 deform and/or intentionally press panel 24. For example, controller 12 may compare change in capacitance measurements from electrodes 42/44 associated with a subsequent interaction by touch object 26 with the generated deformation profile. If the data is similar to the deformation profile (i.e., similar magnitudes 65/69 from a similar number and/or configuration of electrodes 42/44, etc.), controller 12 may determine that the subsequent interaction by touch object 26 is an intentional press. If, however, the data is not similar to the deformation profile or is not within a predetermined tolerance (i.e., smaller magnitudes 65/69 from electrodes 42/44, etc.), controller 12 may determine that the subsequent interaction by touch object 26 is not an intentional press. Furthermore, as discussed above, controller 12 may update stored deformation profiles (i.e., based on feedback from a touch-sensitive-display application) in order to more accurately detect intentional presses of panel 24.

FIG. 7 illustrates an example method 700 that may be used in certain embodiments to determine whether an object has pressed an active touch area of a touch sensor. Method 700 begins in step 710 where capacitances are measured at each of a plurality of sense electrodes distributed across a panel. In certain embodiments, the capacitances are detected by sense electrodes such as electrodes 42/44 described above. In certain embodiments, a controller, such as controller 12 described above, measures the capacitances using data from the sense electrodes. In certain embodiments, the panel may refer to panel 24 described above. In some embodiments, the capacitances measured in step 710 refer to changes in capacitance at the sense electrodes caused by a touch object pressing the active touch area, lightly touching or grazing the active touch area, or coming into close proximity to the active touch area without physically touching the active touch area.

In step 720, the measured capacitances of step 710 are compared with one or more criteria associated with a deformation of the panel. In certain embodiments, the comparison of the capacitance to one or more criteria may refer to the various analyses discussed above. For example, the number of sense electrodes reporting a change in capacitance in step 710 may be determined and compared to a predetermined limit as discussed above. In certain embodiments, an area of the panel in which sense electrodes have sensed a change in capacitance may be calculated, and the calculated area may then be compared with a predetermined area. In certain embodiments, a graph of the capacitances measured in step 710 may be generated and compared to an existing capacitance graph.

In step 730, it is determined, based on the comparison of step 720, whether an object has pressed the panel. In certain embodiments, it may be determined that the object has pressed the panel if the number of sense electrodes reporting a change in capacitance in step 710 exceeds a predetermined limit, if the calculated area of the panel in which sense electrodes have sensed a change in capacitance exceeds a predetermined area, or if the shape of the generated graph of capacitances is similar to an existing capacitance graph that is associated with a deformation of and/or an intentional press of the panel. Conversely, it may be determined that the object has not pressed the panel if the number of sense electrodes reporting a change in capacitance in step 710 does not exceed a predetermined limit, if the calculated area of the panel in which sense electrodes have sensed a change in capacitance does not exceed a predetermined area, or if the shape of the generated graph of capacitances is not similar to an existing capacitance graph that is associated with a deformation of and/or an intentional press of the panel. After step 730, method 700 ends.

FIGS. 8-9 are example capacitance charts that illustrate capacitance magnitudes obtained from an experiment conducted using a sample embodiment of the disclosure. In the experiment, a rectangular touch sensor was constructed using a panel overlaying a grid of x-axis drive electrodes and y-axis sense electrodes. The panel of the rectangular touch sensor included a y-dimension that was greater than the x-dimension. For stability reasons, the rectangular touch sensor was braced in a way to only allow it to bend in the y-dimension. The sense electrodes were communicatively coupled to a controller. The sense electrodes detected changes in capacitance for two scenarios: 1) a hard press of the panel using a person's finger (FIG. 8), and 2) a light touch of the panel using a person's finger (FIG. 9). The capacitance magnitudes were communicated to the controller by the sense electrodes. The controller measured the magnitudes and recorded the values. Capacitance charts for each scenario are discussed in more detail below.

FIG. 8 is a capacitance chart illustrating capacitance magnitudes measured from a hard press of the panel using a person's finger. FIG. 8 includes an x-axis, a y-axis, and a z-axis, as illustrated. The x-axis is the y-axis sense electrodes, and the y-axis is the x-axis drive electrodes. The z-axis indicates the measured change in capacitance. The hard press of the panel resulted in many sense electrodes reporting a change in capacitance, an indication that the panel was deformed by the press. For example, in addition to the large change in capacitances measured at the location of the finger press (as indicated by the large spike near the center of the x-axis), many of the y-axis sense electrodes also reported changes in capacitance. This can be seen by the hump-shape of the graph along the y-axis. Notably, the shape along the x-axis is relatively flat. This was a result of the rectangular touch sensor being braced in a way to only allow it to bend in the y-dimension.

In contrast to FIG. 8, FIG. 9 is a capacitance chart illustrating capacitance magnitudes measured from a light touch of the panel using a person's finger. As can be seen by comparing FIGS. 8 and 9, the light touch of FIG. 8 did not result in many sense electrodes reporting a change in capacitance other than those in the direct vicinity of the touch (as indicated by the large spike near the center of the x-axis). Rather, the sense electrodes not in close proximity to the finger touch reported little or no change in capacitance. This indicates that the panel of the touch sensor was not deformed as it was in FIG. 9.

Accordingly, example embodiments disclosed herein may facilitate distinguishing an intentional press of a touch sensor by a touch object from situations where the touch object merely comes in close proximity to the touch sensor or lightly touches the touch sensor. Certain applications may benefit from this information in a variety of ways. For example, certain applications may use this information to dynamically adapt the behavior of a touch screen based at least in part on whether a user intentionally pressed the touch screen.

Although the preceding examples given here generally rely on self capacitance or mutual capacitance to operate, other embodiments of the invention will use other technologies, including other capacitance measures, resistance, or other such sense technologies.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A touch sensor comprising:
a panel;
a plurality of sense electrodes underlying the panel;
a plane of known potential underlying the plurality of sense electrodes; and
a controller communicatively coupled to the plurality of sense electrodes, the controller configured to distinguish between when an object intentionally presses the panel and when the object is detected by the plurality of sense electrodes but does not intentionally press the panel, the distinguishing comprising:
measuring capacitances at each of the plurality of sense electrodes across the panel, the capacitances associated with a distance between the plurality of sense electrodes and the plane of known potential;
determining a graph of the measured capacitances; and
determining whether the object intentionally pressed the panel based on the determined graph of the measured capacitances.

2. The touch sensor of claim 1, the distinguishing further comprising determining a maximum magnitude of the determined graph of the measured capacitances.

3. The touch sensor of claim 2, wherein determining whether the object intentionally pressed the panel comprises:
determining that the object intentionally pressed the panel when the determined maximum magnitude of the determined graph is greater than or equal to a predetermined threshold; and
determining that the object did not intentionally press the panel when the determined maximum magnitude of the determined graph is less than the predetermined threshold.

4. The touch sensor of claim 1, wherein determining whether the object intentionally pressed the panel comprises:
calculating an area of the determined graph in which one or more of the plurality of sense electrodes have sensed a change in capacitance;
comparing the calculated area with a predetermined area;
determining that the object intentionally pressed the panel when the calculated area is greater than or equal to the predetermined area; and
determining that the object did not intentionally press the panel when the calculated area is less than the predetermined area.

5. A touch sensor comprising:
a panel;
a plurality of sense electrodes underlying the panel;
a plane of known potential underlying the plurality of sense electrodes; and
a controller communicatively coupled to the plurality of sense electrodes, the controller configured to determine whether an object has pressed the panel by:
measuring capacitances at each of the plurality of sense electrodes across the panel, the capacitances associated with a distance between the plurality of sense electrodes and the plane of known potential;
comparing the measured capacitances across the panel with one or more criteria associated with a deformation of the panel; and
determining, based on the comparison, whether an object has pressed the panel.

6. The touch sensor of claim 5, wherein:
the one or more criteria associated with a deformation of the panel comprises a predetermined number of the plurality of sense electrodes that sense a change in capacitance; and
comparing the measured capacitances across the panel with one or more criteria associated with a deformation of the panel comprises:
determining, from the measured capacitances across the panel, a number of the plurality of sense electrodes that sensed a change in capacitance; and
comparing the determined number with the predetermined number.

7. The touch sensor of claim 6, wherein determining, based on the comparison, whether the object has pressed the panel comprises:
determining that the object has not pressed the panel when the determined number is less than the predetermined number; and
determining that the object has pressed the panel when the determined number is greater than or equal to the predetermined number.

8. The touch sensor of claim 5, wherein:
the one or more criteria associated with a deformation of the panel comprises a predetermined area of the panel; and
comparing the measured capacitances across the panel with one or more criteria associated with a deformation of the panel comprises:
calculating, from the measured capacitances across the panel, an area of the panel in which one or more of the sense electrodes have sensed a change in capacitance; and
comparing the calculated area with the predetermined area.

9. The touch sensor of claim 8, wherein determining, based on the comparison, whether the object has pressed the panel comprises:
determining that the object has not pressed the panel when the determined area is less than the predetermined number; and
determining that the object has pressed the panel when the determined number is greater than or equal to the predetermined number.

10. The touch sensor of claim 5, wherein:
the one or more criteria associated with a deformation of the panel comprises a predetermined shape of a graph of measured capacitances of the plurality of sense electrodes; and
comparing the measured capacitances across the panel with one or more criteria associated with a deformation of the panel comprises:
determining a graph of the measured capacitances; and
comparing the determined graph with the predetermined shape of the graph of measured capacitances.

11. The touch sensor of claim 5, wherein the one or more criteria associated with a deformation of the panel comprises a deformation profile.

12. The touch sensor of claim 5, wherein determining whether the object has pressed the panel comprises distinguishing between when the object deforms the panel and when the object is detected by the sense electrodes but does deform the panel.

13. A method comprising:
measuring, by a controller, capacitances at each of a plurality of sense electrodes underlying a panel of a touch-sensitive device, the capacitances associated with a distance between the plurality of sense electrodes and a plane of known potential of the touch-sensitive device;
determining, by the controller, a graph of the measured capacitances; and
determining, by the controller based on the determined graph of the measured capacitances, whether an object intentionally pressed the panel of the touch-sensitive device.

14. The method of claim 13, further comprising determining a maximum magnitude of the determined graph of the measured capacitances.

15. The method of claim 14, wherein determining whether the object intentionally pressed the panel comprises:
determining that the object intentionally pressed the panel when the determined maximum magnitude of the determined graph is greater than or equal to a predetermined threshold; and
determining that the object did not intentionally press the panel when the determined maximum magnitude of the determined graph is less than the predetermined threshold.

16. The method of claim 14, wherein determining whether the object intentionally pressed the panel comprises:
calculating an area of the determined graph in which one or more of the plurality of sense electrodes have sensed a change in capacitance;
comparing the calculated area with a predetermined area;
determining that the object intentionally pressed the panel when the calculated area is greater than or equal to the predetermined area; and
determining that the object did not intentionally press the panel when the calculated area is less than the predetermined area.

17. A touch sensor comprising:
a panel;
a plurality of sense electrodes underlying the panel; and
a controller configured to determine whether an object has pressed the panel by:
measuring capacitance changes at each of the plurality of sense electrodes across the panel, the capacitance changes caused by an object;
accessing a deformation profile associated with the panel;
determining whether the object has deformed the panel by comparing the measured capacitance changes across the panel with the deformation profile.

18. The touch sensor of claim 17, the controller further configured to generate the deformation profile using measured capacitance changes at each of the plurality of sense electrodes across the panel.

19. The touch sensor of claim 17, the deformation profile indicating a particular pattern of the plurality of sense electrodes that sense a change in capacitance when the panel is pressed.

20. The touch sensor of claim 17, the deformation profile comprising one or more of:
a minimum number of the plurality of sense electrodes that sense a change in capacitance;
a predetermined threshold for the measured capacitance changes; and
a specific shape of a graph of the measured capacitance changes.
